(19) United States
(12) Patent Application Publication
(10) Pub. No.: US 2026/0228868 A1
(43) Pub. Date: Aug. 6, 2026

(54) PROCESSING APPARATUS, PROCESSING METHOD, AND STORAGE MEDIUM

(71) Applicant: CANON KABUSHIKI KAISHA, Tokyo (JP)

(72) Inventor: Tomohiro NISHIYAMA, Tokyo (JP)

(21) Appl. No.: 19/576,439

(22) Filed: Mar. 24, 2026

Related U.S. Application Data
(63) Continuation of application No. PCT/JP2024/029264, filed on Aug. 19, 2024.

(30) Foreign Application Priority Data
Nov. 9, 2023 (JP) 2023-191223

(51) Int. Cl. G06T 5/80

(52) U.S. Cl. CPC G06T 5/80; G06T 2207/10028

(57) ABSTRACT

A processing apparatus includes one or more memories storing instructions, and one or more processors that, upon execution of the instructions, operate to generate a distance image when viewed from a second viewpoint by using distance information to an object when viewed from a first viewpoint, and determine whether to correct a distance value of a pixel included in a neighborhood region of a reference pixel in the distance image, according to the distance value of the pixel included in the neighborhood region.

### CROSS-REFERENCE TO RELATED APPLICATIONS

This application is a Continuation of International Patent Application No. PCT/JP2024/029264, filed on August 19, 2024, which claims the benefit of Japanese Patent Application No. 2023-191223, filed on November 9, 2023, both of which are hereby incorporated by reference herein in their entirety.

### BACKGROUND

### Field of the Technology

The present disclosure relates to a processing apparatus, a processing method, and a storage medium.

### Description of the Related Art

Three-dimensional distance information for a variety of applications has recently been demanded to have high accuracy and high density. As an acquiring unit for high-accuracy three-dimensional distance information, three-dimensional distance measuring apparatuses such as LiDAR sensors are known.

On the other hand, high-density three-dimensional distance information requires a long acquisition time, making it difficult to apply to moving objects, and also involves a large amount of information, thereby increasing processing load. Xinjing Cheng, Peng Wang and Ruigang Yang, “Depth Estimation via Affinity Learned with Convolutional Spatial Propagation Network” discloses a method for converting three-dimensional distance information into a depth map format. A depth map is image data in which each pixel stores a value corresponding to the distance to an object (such as a value proportional to the distance) as a pixel value. In general, since three-dimensional distance measuring apparatuses acquire data at constant sampling intervals, pixels having no pixel value may occur when the data are projected onto a depth map. Inputting such a sparse depth map together with an image captured by a camera into a Convolutional Neural Network (CNN) can provide a dense depth map in which pixel values are stored for all pixels.

In a case where the viewpoint positions of a three-dimensional distance measuring apparatus and a camera are different from each other, the shielding relationships among objects when viewed from each of the three-dimensional distance measuring apparatus and the camera may differ from each other. That is, a situation may occur in which a distant object that is not shielded when viewed from the three-dimensional distance measuring apparatus is shielded by a neighborhood object when viewed from the camera. In such a situation, when a depth map viewed from the camera is generated, because the depth map is sparse, a value corresponding to the distance of the distant object may be stored in the depth map. Therefore, when a dense depth map is generated using the method disclosed in Xinjing Cheng, Peng Wang and Ruigang Yang, “Depth Estimation via Affinity Learned with Convolutional Spatial Propagation Network,” distance values near object boundaries are inaccurate, and accurate three-dimensional distance information cannot be reproduced.

### SUMMARY

A processing apparatus according to one aspect of the present disclosure may include one or more memories storing instructions, and one or more processors that, upon execution of the instructions, operate to generate a distance image when viewed from a second viewpoint by using distance information to an object when viewed from a first viewpoint, and determine whether to correct a distance value of a pixel included in a neighborhood region of a reference pixel in the distance image, according to the distance value of the pixel included in the neighborhood region. A processing method corresponding to the above processing apparatus also constitutes another aspect of the present disclosure. A storage medium storing a program that causes a computer to execute the above processing method also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of a three-dimensional distance information processing apparatus according to a first embodiment.

FIG. 2 is a flowchart illustrating three-dimensional distance information processing.

FIGS. 3A and 3B are conceptual diagrams illustrating the acquisition of three-dimensional distance information and an image.

FIG. 4 is a flowchart illustrating depth correction processing according to the first embodiment.

FIG. 5 is an explanatory diagram illustrating the effects of the configuration according to the first embodiment.

FIG. 6 is a conceptual diagram illustrating an operation of a depth corrector according to a second embodiment.

FIG. 7 is a flowchart illustrating depth correction processing according to the second embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the present disclosure. Corresponding elements in respective figures will be designated by the same reference numerals, and a duplicate description thereof will be omitted.

### FIRST EMBODIMENT

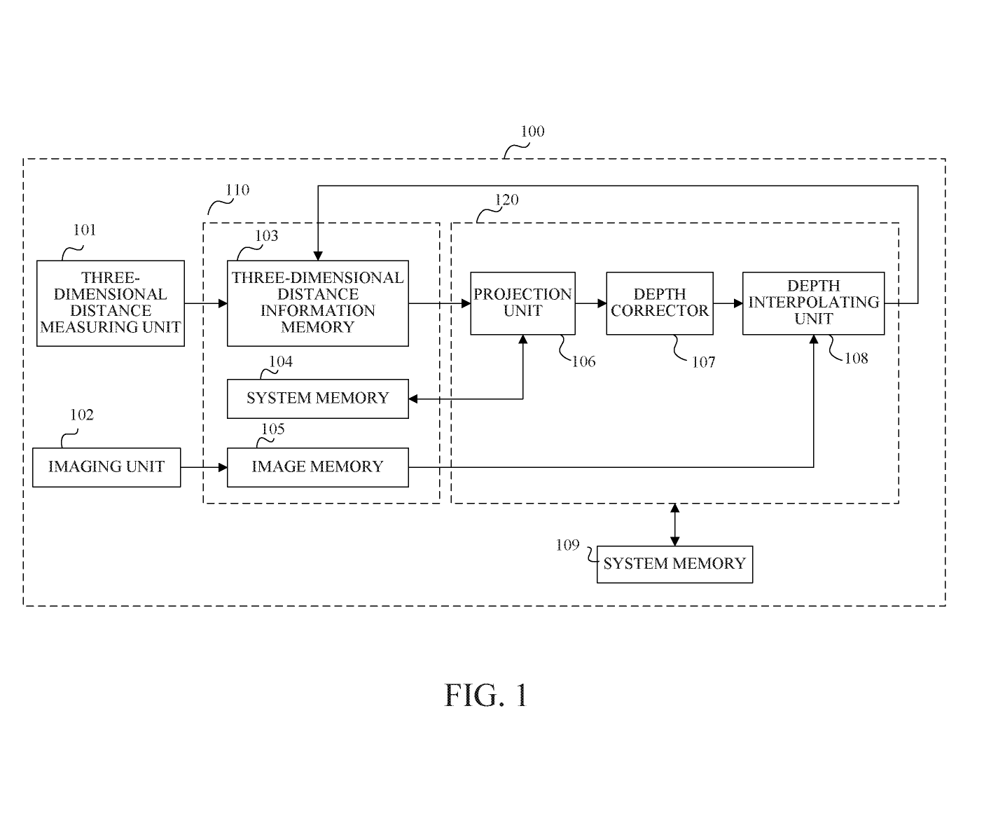

FIG. 1 is a block diagram of a three-dimensional distance information processing apparatus (processing apparatus) 100 according to the present embodiment. The three-dimensional distance information processing apparatus 100 includes a three-dimensional distance measuring unit 101, an imaging unit 102, a system memory 109, a nonvolatile memory 110, and a control unit 120. The system memory 109 and the nonvolatile memory 110 serve as one or more memories storing instructions.

The three-dimensional distance measuring unit 101 includes, for example, a LiDAR sensor. The LiDAR sensor includes a ray output unit that outputs laser light and irradiates a surface of an object with a ray (irradiation ray), and a receiver that receives a reflected ray from the surface of the object. Distance data to a structure surface in an irradiation direction is acquired using a time until the reflected ray returns or a phase difference between the irradiation ray and the reflected ray, and three-dimensional distance information (distance information to an object viewed from a first viewpoint) is acquired by combining the distance data with information in the irradiation direction. The three-dimensional distance measuring unit 101 is not limited to a LiDAR sensor, and may be a device that performs distance measurement using electromagnetic waves other than laser light, sound waves, or the like. The three-dimensional distance information is assumed to include at least one of a point cloud, voxels, polygons, meshes, implicit surface representations, a depth map, a parallax map, and a depth image.

The imaging unit 102 includes, for example, a camera. The camera includes a lens unit, an image sensor that converts an optical image into an electrical signal, and an A/D converter that converts an analog signal into a digital signal. An optical image is input to the image sensor via the lens unit, and the electrical signal converted by the image sensor is converted into a digital signal, thereby acquiring an image (captured image).

The system memory 109 is a rewritable volatile memory such as a DRAM, and expands constants, variables, and data read from the nonvolatile memory 110 during operation of the control unit 120.

The nonvolatile memory 110 includes a three-dimensional distance information memory 103, a system memory 104, and an image memory 105. The nonvolatile memory 110 is an electrically erasable and writable memory, such as an EEPROM. The three-dimensional distance information memory 103 stores three-dimensional distance information acquired from the three-dimensional distance measuring unit 101 based on a predefined format, for example, in a point cloud format. The system memory 104 stores operation programs of each block included in the control unit 120 and constants for operation. The programs referred to here are programs for executing a variety of flowcharts described later in the present embodiment. The image memory 105 stores images acquired from the imaging unit 102.

The control unit 120 includes at least one processor (one or more processors) and controls the entire three-dimensional distance information processing apparatus 100. The control unit 120 includes a projection unit (generator) 106, a depth corrector (corrector, setting unit) 107, and a depth interpolating unit (interpolating unit) 108. The control unit 120 implements each processing of the present embodiment described later by executing programs (instructions) stored in the system memory 109 (one or more memories). That is, the control unit 120, upon execution of the instructions operate to serve as the projection unit 106, the depth corrector 107, and the interpolating unit 108. Various types of control performed by the control unit 120 may be performed by a single piece of hardware, or may be distributed and performed by a plurality of pieces of hardware, such as a plurality of processors or circuits.

The projection unit 106 generates a depth map viewed from the imaging unit 102 (a distance image viewed from a second viewpoint), based on the three-dimensional distance information recorded in the three-dimensional distance information memory 103 and relative position information between the three-dimensional distance measuring unit 101 and the imaging unit 102 recorded in the system memory 104. Here, the depth map is image data in which a value corresponding to a distance to an object (such as a value proportional to the distance) is stored as a pixel value for each pixel. In the present embodiment, a value obtained by projecting a position vector of the object viewed from the imaging unit 102 onto an optical axis direction is adopted as the pixel value, but a length of the position vector may be adopted instead. Although the present embodiment discusses a case in which the distance image is a depth map, a parallax map or a depth image may also be used.

In the present embodiment, a pixel value of 0 is assigned to a pixel corresponding to a distance of 0 [mm] to an object, and a pixel value of 255 is assigned to a pixel corresponding to a distance equal to or greater than a threshold value (such as 100000 [mm] = 100 [m]) to an object. For a pixel for which there is no corresponding distance to an object, a pixel value of 0 is stored. In the following description, in order to distinguish from pixel values of an image acquired by the imaging unit 102, pixel values on the depth map will be referred to as distance values. These values may not coincide with physical distances.

Since a LiDAR sensor scans laser light based on a constant angular resolution, the obtained depth map generally includes a certain number of pixels in which distance values are missing. Although the number of scans can be increased for finer sampling, the acquisition of three-dimensional distance information requires a longer time, and such a method cannot be used in a case where a moving object is present. The amount of three-dimensional distance information becomes enormous. In the following description, a depth map including pixels in which distance values are missing will be referred to as a sparse depth map. The number of pixels of the depth map may be different from the number of pixels of an image acquired by the imaging unit 102. The sparse depth map is stored in the system memory 104 and the system memory 109.

The depth corrector 107 determines whether to correct distance values according to distance values of pixels included in a neighborhood region around a reference pixel of the sparse depth map output from the projection unit 106. For example, the depth corrector 107 may determine whether to correct distance values according to a difference between a distance value of each pixel included in the neighborhood region and a distance value of the reference pixel (reference distance value), or according to magnitudes of distance values of the pixels included in the neighborhood region.

The depth interpolating unit 108 generates a depth map (referred to as a dense depth map hereinafter) in which distance values are stored for all pixels, based on the sparse depth map corrected by the depth corrector 107 and the image acquired by the imaging unit 102. For example, the dense depth map can be generated using a Convolutional Neural Network (CNN) from a combination of the image and the corresponding sparse depth map. Interpolation may also be performed using at least one of filtering, machine learning, super-resolution, and a conditional random field.

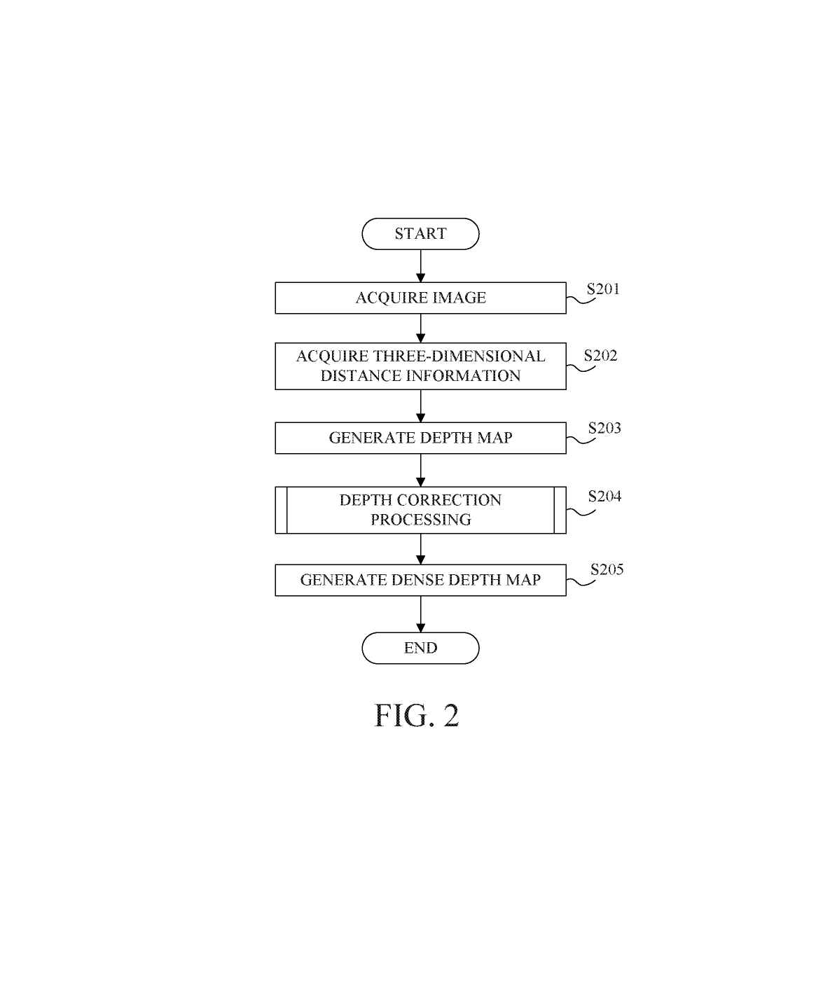

FIG. 2 is a flowchart illustrating three-dimensional distance information processing. In step S201, the image memory 105 acquires an image from the imaging unit 102 and records the image. In step S202, the three-dimensional distance information memory 103 acquires three-dimensional distance information from the three-dimensional distance measuring unit 101 and stores the information. In step S203, the projection unit 106 generates a depth map viewed from the imaging unit 102, based on the three-dimensional distance information recorded in the three-dimensional distance information memory 103 and the relative position information between the three-dimensional distance measuring unit 101 and the imaging unit 102 recorded in the system memory 104. In the present embodiment, the relative position information between the three-dimensional distance measuring unit 101 and the imaging unit 102 is assumed to be known, but the present disclosure is not limited to this embodiment. For example, the relative position information may be calculated using a known calibration method by matching feature points in a three-dimensional point cloud and an image. In step S204, the depth corrector 107 executes depth correction processing to correct distance values of the depth map. In step S205, the depth interpolating unit 108 generates a dense depth map based on the corrected depth map and the image.

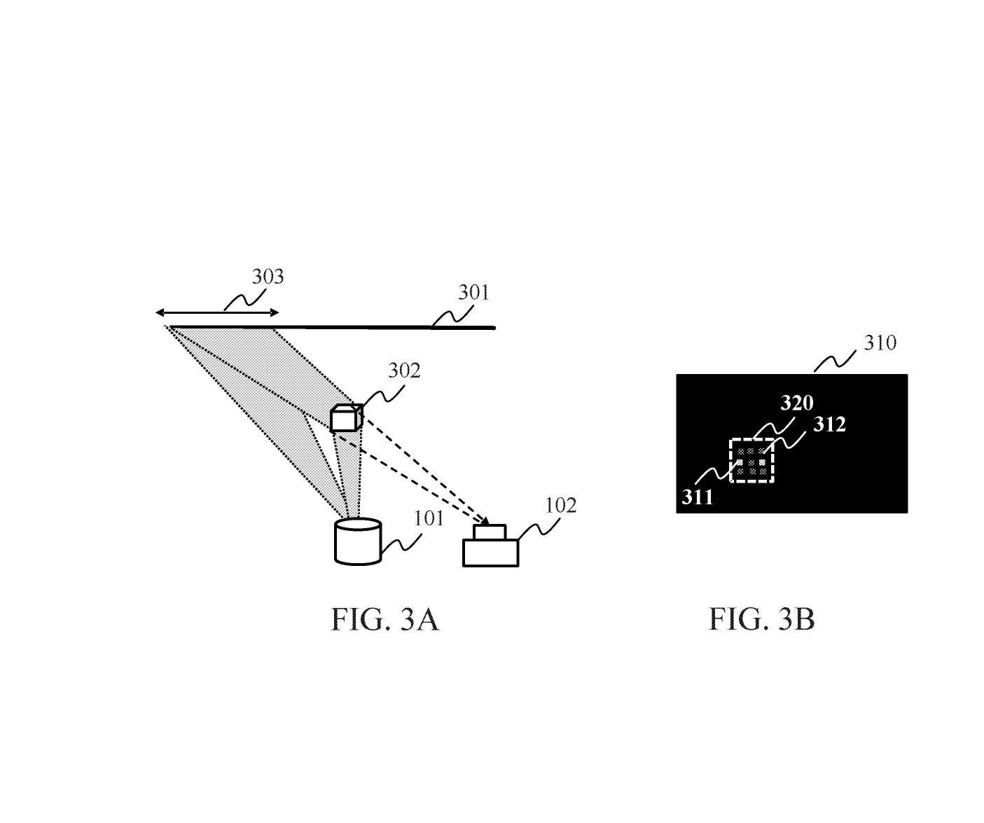

Next, processing of step S204 in FIG. 2 (depth correction processing) will be described. FIGS. 3A and 3B are conceptual diagrams illustrating the acquisition of three-dimensional distance information and an image using the three-dimensional distance measuring unit 101 and the imaging unit 102. In FIG. 3A, a region 303 is a region on a wall 301 that is shielded by an object 302 when viewed from the imaging unit 102. In FIG. 3B, a region 320 of a depth map 310 generated by the projection unit 106 viewed from the imaging unit 102 corresponds to the object 302. For convenience of illustration, distance values outside the region 320 are illustrated as 0, but in practice other values are stored. Within the region 320, a pixel 311 stores a distance value corresponding to a distance to the wall 301, and a pixel 312 stores a distance value corresponding to a distance to the object 302.

Since the three-dimensional distance measuring unit 101 and the imaging unit 102 are located at different positions in space, parallax differs between the wall 301 and the object 302. That is, the region 303 does not originally appear on the depth map when viewed from the imaging unit 102 because it is shielded by the object 302. However, since data acquired by the three-dimensional distance measuring unit 101 is sparse, distance values derived from the wall 301 and distance values derived from the object 302 are mixed in the region 320. Thus, when interpolation processing is performed, distance values in the region 320 are averaged, and distance values different from the actual ones are stored. In FIGS. 3A and 3B, parallax between the three-dimensional distance measuring unit 101 and the imaging unit 102 is emphasized, but actual parallax is not as large as illustrated, and therefore a phenomenon occurs in which distance values become inaccurate near boundaries, particularly for objects closer to the imaging unit 102.

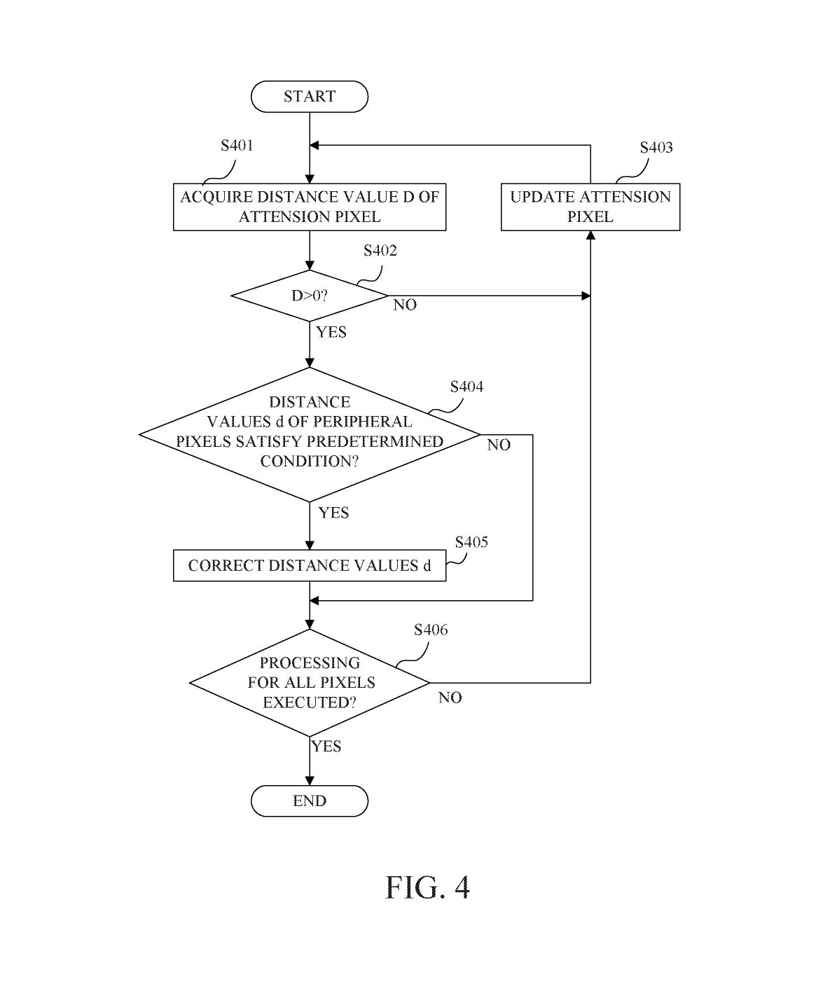

To solve the above problem, the present embodiment corrects distance values derived from the wall 301 within the region 320 in accordance with the flow of FIG. 4. FIG. 4 is a flowchart illustrating depth correction processing according to the present embodiment.

In step S401, the depth corrector 107 acquires a distance value (reference distance value) D of an attention pixel (pixel of interest, reference pixel) in the depth map.

In step S402, the depth corrector 107 determines whether the distance value D is greater than 0. In a case where the distance value D is determined to be greater than 0, the flow proceeds to step S404. In a case where the distance value D is determined to be equal to 0, the flow proceeds to step S403.

In step S403, the depth corrector 107 updates the attention pixel.

In step S404, the depth corrector 107 determines whether a distance value d of a neighborhood pixel included in a neighborhood region of the attention pixel satisfies a predetermined condition. In the present embodiment, the depth corrector 107 determines whether a difference value d-D between the distance value d of the neighborhood pixel and the distance value D is greater than a threshold value (first predetermined value) Th1. Here, the neighborhood region is set by the depth corrector 107, and is a square region of (2b+1)×(2b+1) pixels centered on the attention pixel, and may include the attention pixel. For example, b is 1 [pixel]. The shape of the neighborhood region is not limited to a square, and may be another shape such as a rectangle or a circle. The size of the neighborhood region may be changed according to the distance value D. For example, in a case where the three-dimensional distance measuring unit 101 and the imaging unit 102 are located approximately on the same plane, parallax therebetween is proportional to a value 1/D, and thus the size of the neighborhood region may be set to be proportional to the value 1/D. This utilizes a characteristic that little parallax occurs between distant objects. In a case where the difference value d-D is determined to be greater than the threshold value Th1, the flow proceeds to step S405. In a case where the difference value d-D is determined to be smaller than the threshold value Th1, the flow proceeds to step S406. In a case where difference value d-D is equal to the threshold value Th1, which step is executed may be arbitrarily set. In the present embodiment, distance values d of neighborhood pixels are corrected in a case where the distance values d are greater than the distance value D by more than the threshold value. Alternatively, distance values may be corrected in a case where the distance values d are greater than another threshold value (second predetermined value). This corresponds to correcting distance values corresponding to distances to objects existing farther than a certain distance.

In step S405, the depth corrector 107 corrects the distance value d of the neighborhood pixel. In the present embodiment, the distance value d is corrected to 0. This corresponds to deleting distance values corresponding to distances to distant objects existing within the neighborhood region. The reason why the distance value d may be set to 0 is that a proper distance value is filled from neighborhood pixels by the processing (interpolation processing) of step S205. The distance value d may instead be corrected to a value close to the distance value D.

In step S406, the depth corrector 107 determines whether the above processing has been executed for all pixels as attention pixels. In a case where it is determined that the processing has been executed for all pixels, the flow ends. Otherwise, the flow returns to step S403.

As described above, the present embodiment corrects a sparse depth map viewed from the imaging unit 102, and thus can acquire a dense depth map in which boundaries of objects are reproduced with high accuracy by interpolation processing.

In a case where the distance value D of the attention pixel is equal to or greater than a predetermined value (third predetermined value), parallax is suppressed, and therefore the depth correction processing may be configured not to be executed.

Although the present embodiment has described an example in which distance values in a neighborhood region are corrected, the present disclosure is not limited to the present embodiment. For example, in a case where a difference D-d_min between the distance value D of the reference pixel and a minimum distance value d_min (or a median value or an average value) of distance values in the neighborhood region is greater than the first predetermined threshold value, the distance value D of the reference pixel may be corrected to the minimum value d_min.

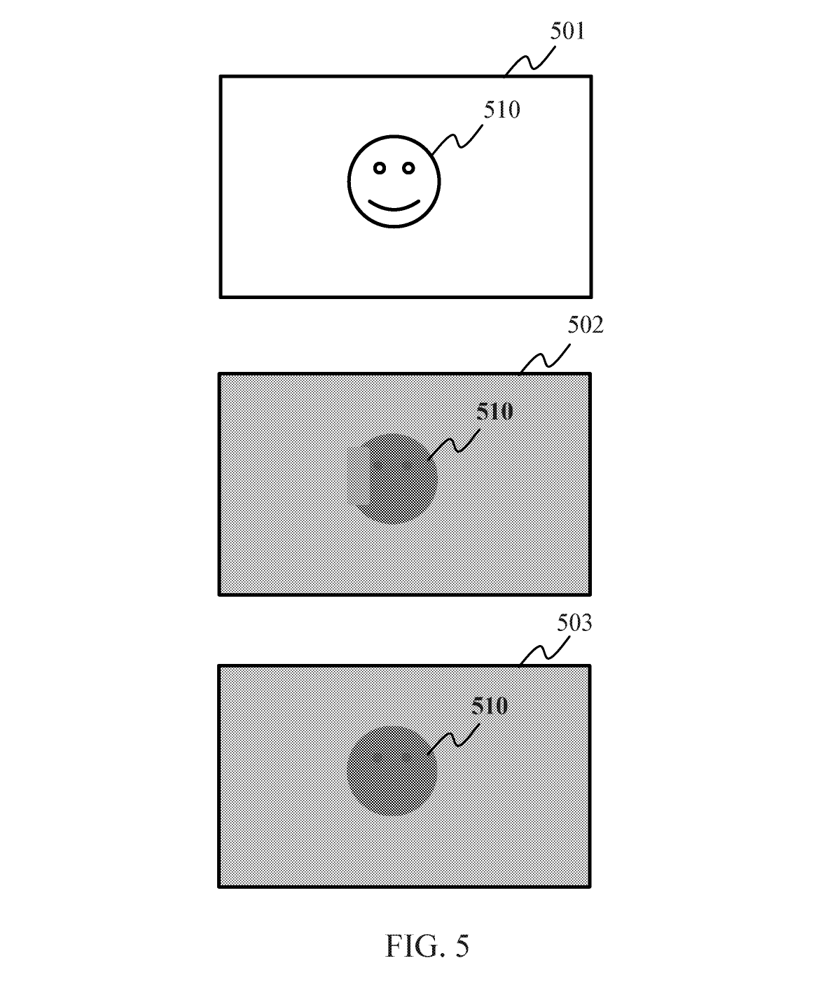

FIG. 5 is an explanatory diagram illustrating the effects of the configuration of the present embodiment. An image 501 is a captured image obtained by imaging an object 510 with the imaging unit 102. By executing the depth correction processing, compared with a depth map 502 obtained without executing the depth correction processing, defects of the object are reduced, and it is possible to obtain a highly accurate and high-density depth map 503.

As described above, the configuration of the present embodiment can acquire highly accurate and high-density three-dimensional distance information.

### SECOND EMBODIMENT

In the present embodiment, the depth corrector 107 determines whether to correct a depth map also using information on an image acquired by the imaging unit 102. In the following, only configurations different from those of the first embodiment will be described, and a description of configurations common to that of the first embodiment will be omitted.

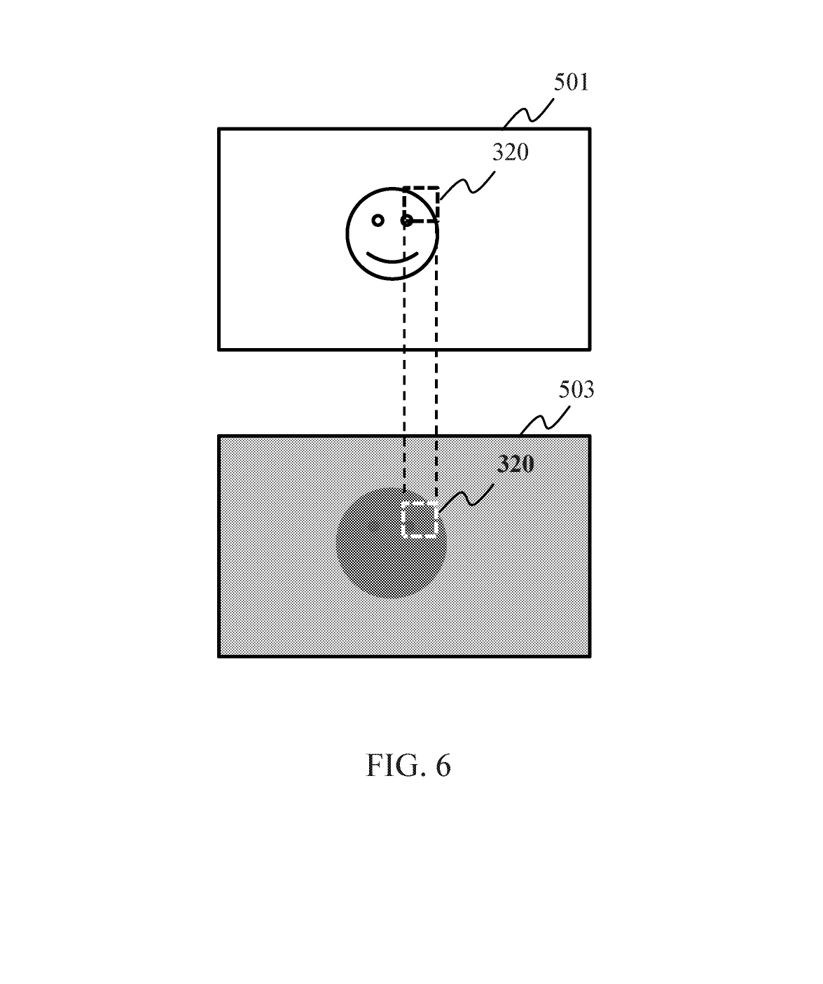

FIG. 6 is a conceptual diagram illustrating an operation of the depth corrector 107 according to the present embodiment, and shows a state in which a region 320 is superimposed on an image 501 and a depth map 503. The depth corrector 107 corrects distance values within the region 320 to distance values of an object 510. As a result of interpolation processing, as illustrated in FIG. 6, a region having distance values of the object 510 may be expanded outward beyond an original object boundary. This problem becomes more significant particularly when the object boundary is complex. Accordingly, in the present embodiment, whether to perform correction is switched by comparing pixel values of a pixel of interest and neighborhood pixels included in a neighborhood region in the image 501. In the following description, it is assumed that the image 501 and the depth map 503 have the same number of pixels, but they may be different. In such a case, a pixel value on the image 501 corresponding to a pixel on the depth map 503 is acquired.

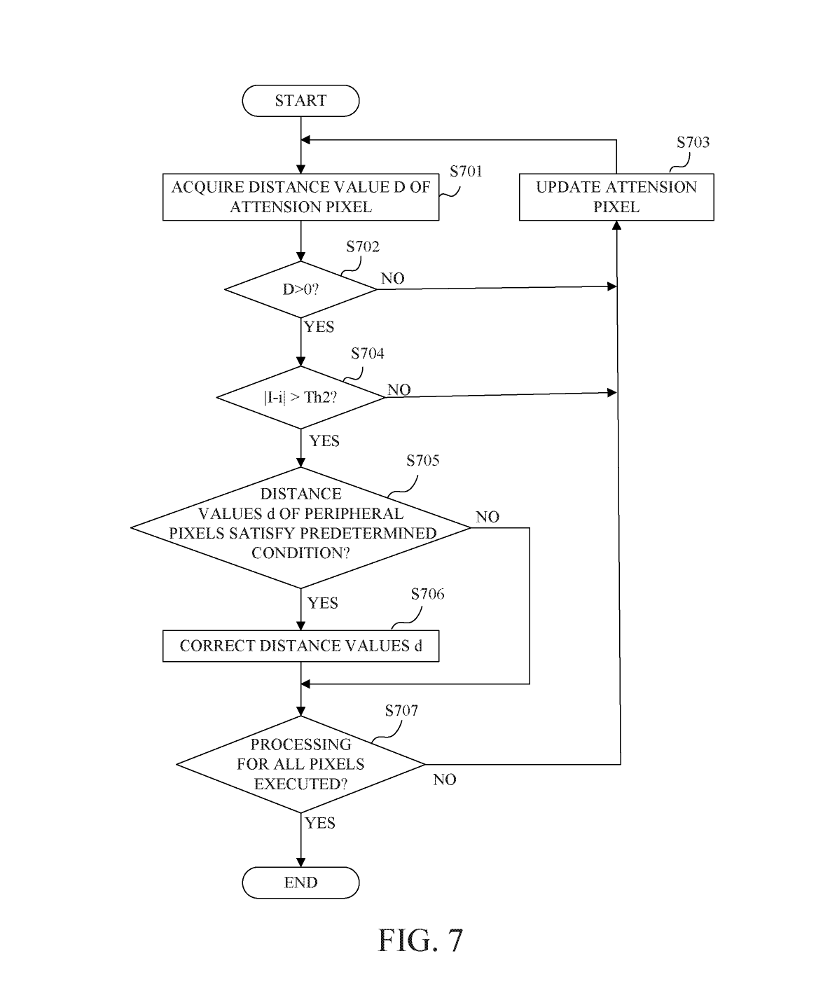

FIG. 7 is a flowchart illustrating depth correction processing according to the present embodiment.

The processing of steps S701 to S703 and steps S705 to S707 is the same as that of steps S401 to S406 in FIG. 4, respectively, and thus a description thereof will be omitted.

In step S704, the depth corrector 107 determines whether an absolute value of a difference |I-i| between a pixel value I of an attention pixel in the image 501 acquired by the imaging unit 102 and a pixel value i of a neighborhood pixel included in the neighborhood region is greater than a threshold value (fourth predetermined value) Th2. In a case where the absolute value of the difference |I-i| is determined to be greater than the threshold value Th2, the depth corrector 107 executes the processing of step S705. In a case where the absolute value of the difference |I-i| is determined to be smaller than the threshold value Th2, the processing of step S703 is executed. In a case where the absolute difference |I-i| is equal to the threshold value Th2, which step is executed may be arbitrarily set. In addition, when comparing pixel values, values other than the absolute value of the difference may be used. The purpose of the processing of this step is to identify an object boundary in the image 501, and thus the magnitude of the difference is important, and the sign may be either positive or negative. On the other hand, in the processing of step S705, the sign of a difference in distance values is important in order to identify a relatively distant object.

The present embodiment adopts luminance as a pixel value, but may also use RGB information. In that case, an average value of the results of respective RGB channels, for example, may be adopted. The present disclosure is not limited to the above method as long as a difference between pixel values can be compared.

The present embodiment has described an example in which whether to correct the depth map 503 is determined based on the pixel values of the image 501, but the shape of the neighborhood region may be changed. In that case, in step S704, pixels for which the absolute value of the difference is greater than the threshold value Th2 may be excluded from the neighborhood region.

As described above, the configuration of the present embodiment can reproduce object boundaries with high accuracy, in addition to the effects of the first embodiment.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like. One or more of the functional blocks illustrated in FIG. 1 may be implemented by hardware such as an ASIC or a programmable logic array (PLA), or by a programmable processor such as a CPU or MPU executing software. They may also be implemented by a combination of software and hardware. Therefore, even when different functional blocks are described as the main operation entities in the following description, they may be implemented by the same hardware.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

The present disclosure can provide a processing apparatus capable of acquiring highly accurate and high-density three-dimensional distance information.

What is claimed is:

1. A processing apparatus comprising: one or more memories storing instructions; and one or more processors that, upon execution of the instructions, operate to:generate a distance image when viewed from a second viewpoint by using distance information to an object when viewed from a first viewpoint; anddetermine whether to correct a distance value of a pixel included in a neighborhood region of a reference pixel in the distance image, according to the distance value of the pixel included in the neighborhood region.

2. The processing apparatus according to claim 1, wherein the one or more processors operate: to correct the distance value in a case where a difference between the distance value and a reference distance value of the reference pixel is greater than a first predetermined value, and not to correct the distance value in a case where the difference is smaller than the first predetermined value.

3. The processing apparatus according to claim 1, wherein the one or more processors operate: to correct the distance value in a case where the distance value is greater than a second predetermined value, and not to correct the distance value in a case where the distance value is smaller than the second predetermined value.

4. The processing apparatus according to claim 1, wherein the distance information is acquired using at least one of laser light, electromagnetic waves, and sound waves.

5. The processing apparatus according to claim 1, wherein the distance information includes at least one of a point cloud, voxels, polygons, a mesh, an implicit function representation, a depth map, a parallax map, and a distance map, and wherein the distance image includes any one of a depth map, a parallax map, and a distance map.

6. The processing apparatus according to claim 1, wherein the neighborhood region includes a plurality of pixels including the reference pixel, and wherein the one or more processors operate to correct a distance value of at least one of the plurality of pixels.

7. The processing apparatus according to claim 1, wherein the one or more processors operate not to execute processing for correcting the distance value in a case where a reference distance value of the reference pixel is equal to or greater than a third predetermined value.

8. The processing apparatus according to claim 1, wherein the one or more processors operate to set the neighborhood region.

9. The processing apparatus according to claim 8, wherein the one or more processors operate to set a size of the neighborhood region according to a reference distance value of the reference pixel.

10. The processing apparatus according to claim 1, wherein the second viewpoint is a viewpoint of an imaging unit configured to acquire a captured image.

11. The processing apparatus according to claim 10, wherein the one or more processors operate to determine whether to execute processing for correcting the distance value according to a pixel value of the captured image.

12. The processing apparatus according to claim 11, wherein the one or more processors operate to determine whether to execute the processing based on a magnitude of a difference between a pixel value of a pixel corresponding to the reference pixel in the captured image and a pixel value of a pixel corresponding to a pixel included in the neighborhood region.

13. The processing apparatus according to claim 12, wherein the one or more processors operate: not to execute the processing in a case where an absolute value of the difference is greater than a fourth predetermined value, and to execute the processing in a case where the absolute value of the difference is smaller than the fourth predetermined value.

14. The processing apparatus according to claim 10, wherein the one or more processors operate to set the neighborhood region according to pixel values of the captured image.

15. The processing apparatus according to claim 10, wherein the one or more processors operate to interpolate a distance value of a pixel for which the distance value is missing, by using the corrected distance image and the captured image.

16. The processing apparatus according to claim 15, wherein the one or more processors operate to perform interpolation using at least one of a filter, machine learning, super-resolution, and a conditional random field.

17. A processing method comprising: converting distance information to an object when viewed from a first viewpoint into a distance image when viewed from a second viewpoint; and correcting a distance value according to distance values of a pixel included in a neighborhood region of a reference pixel in the distance image.

18. A non-transitory computer-readable storage medium storing a program that causes a computer to execute the processing method according to claim 17.
